(19) United States
(12) Patent Application Publication
(10) Pub. No.: US 2004/0204968 A1
(43) Pub. Date: Oct. 14, 2004

(54) Method and system for providing rebooking information to passengers

(75) Inventors: Jeffery Mark Bertram, Peachtree City, GA (US); Albert Edward Houck III, Tyrone, GA (US); Christopher Thomas Reese, Duluth, GA (US); Franklin E. McDuffie, Atlanta, GA (US)

Correspondence Address: KING & SPALDING LLP, 191 PEACHTREE STREET, N.E., ATLANTA, GA, 30303-1763, US

(73) Assignee: Delta Air Lines, Inc., Atlanta, GA

(21) Appl. No.: 10/835,931

(22) Filed: Apr. 30, 2004

Related U.S. Application Data
(63) Continuation-in-part of application No. 10/406,960, filed on Apr. 4, 2003.

(51) Int. Cl. G06F 17/60

(52) U.S. Cl. 705/5

(57) ABSTRACT

A computer-implemented system for changing the travel reservation of a passenger based on the detection of a modification event. The system employs a travel monitoring software module that can be used to monitor passengers and anticipate needed changes in reservations. Once a passenger's reservation is rebooked, a local computer system and a local gate information display system can be used to display the updated travel reservation and permit boarding under the new reservation. Passengers can also use scan-print devices to quickly receive a new copy of their travel itinerary reflecting the rebooking. The entire system facilitates the movement of passengers through terminals to their respective departure points. The system also reduces the number of personnel needed to manage irregular travel operations.

### RELATED APPLICATIONS

This patent application is a continuation-in-part of U.S. patent application Ser. No. 10/406,960, filed Apr. 4, 2003, entitled “Method and System for Rebooking a Passenger. This patent application is also related to U.S. patent application Ser. No. 09/724,290, filed Nov. 28, 2000, entitled “Method and System for Remote Check-In with a Carrier”; U.S. patent application Ser. No. 09/968,738, filed Sep. 28, 2001, entitled “System and Method for Boarding Passengers onto Multiple Vehicles”; and U.S. patent application Ser. No. 09/708,890, filed Nov. 8, 2000, entitled “Method and System for Providing Dynamic and Real-Time Air Travel Information.” All of these related applications are assigned to Delta Air Lines, Inc. and the complete disclosure of each related application is incorporated herein by reference.

### TECHNICAL FIELD

The present invention is generally directed to managing the boarding of passengers onto transportation vehicles. More specifically, the present invention provides a system and method that support the rebooking of passengers from one voyage to another and the rapid delivery of rebooking information to the passengers.

### BACKGROUND OF THE INVENTION

Air travel is becoming an increasingly popular means of travel for people today. This popularity has caused the number of airplane flights to increase and a greater volume of travelers to pass through today's airports. The increased number of travelers also causes more congestion and longer lines at the airports. Accordingly, airlines need more efficient ways to handle their passengers.

Airlines generally require passengers to check-in upon arriving at the airport for their flight. The check-in process can serve several functions. For the airline, checking a passenger in confirms the passenger's identity and that a passenger with a reservation is in fact going to travel on the flight. Verifying the passenger's identity assists in eliminating fraud and security threats and fulfills requirements for securing baggage. For the passenger, the check-in process is a means to verify her itinerary, check baggage, and, if not already done, receive a seat assignment. At the completion of the check-in process the passenger is given a traditional boarding card for the particular flight that will permit her to board the airplane. A separate boarding card is typically issued for each segment of a flight itinerary.

Oftentimes, a passenger is required to change her travel plans. A passenger's travel plans may change for a variety of reasons, including inclement weather, carrier equipment problems, or changes in the passenger's personal schedule. Passengers often need to change their travel plans either at the airport or when they are on their way to the airport. Changing a passenger's travel plans generally requires rebooking the passenger on an alternate flight. The rebooking process can be a significant expenditure of time and resources for the carrier and a source of delay and frustration for the passenger because rebooking is a function of seat availability on other flights. Rebooking often requires the passenger to wait long periods of time until they can be booked and, once rebooked, the passenger may have to proceed to a different departure gate at the airport.

The problems associated with rebooking are particularly acute for connecting passengers. Connecting passengers are those passengers whose final destination is different than the airport in which they land. For example, a passenger on an inbound flight may have a reservation on another flight that is scheduled to depart shortly after the inbound flight is supposed to arrive. Various delays associated with air travel can cause connecting passengers to miss their connections. When connecting passengers miss their connections, this causes a significant added burden for the carrier. First, the carrier must locate availability on a later flight for the passenger. Second, the manual process of rebooking connecting passengers and assisting passengers whose travel plans change has a significant associated cost in the human resources of the carrier. Similarly, manually rebooking passengers creates a bottleneck that slows down the process and adds stress and inconvenience for the passenger. Third, the rebooking process can delay the checking-in and boarding processes of other flights that would otherwise be unaffected by the original delay. Finally, the carrier may incur an opportunity cost if it is unable to resell the seat originally reserved for the connecting passenger.

While some carriers have attempted to solve some of these rebooking problems using self-serve electronic kiosks placed in a terminal, these kiosks have had limited success. Users are often unfamiliar with how to use the kiosks to rebook their travel itinerary. Furthermore, the conventional electronic kiosks typically require several interactions between the user and the kiosk in order to complete a rebooking or to provide the passenger with rebooking information. For example, the user may have to input several pieces of information and make multiple selections to perform the rebooking or to receive the desired information. Conventional electronic kiosks are not designed to provide rebooking information to users in a rapid fashion with minimal interactions. For this reason, conventional electronic kiosks are ill-suited to quickly provide rebooking information to a large number of passengers, such as when bad weather causes an irregular operation for a carrier.

Accordingly, there is a need for a more efficient means for rebooking passengers when their travel plans change and providing the passengers with the rebooking information. Specifically, there is a need for a carrier to be able to anticipate those passengers that need to change their travel plans and to easily rebook those passengers on the next available flight. Once the rebooking is accomplished, there is a need to deliver the rebooking information expediently to the affected passengers so that they can proceed directly to the appropriate departure gate. Finally, because passengers often desire to have new documents reflecting their rebooking information, there is a further need to provide passengers with new documents rapidly and without significantly burdening additional carrier personnel. While these problems have been described in the context of the airline industry, they exist throughout the transportation industry as well as other industries that manage large volumes of people or cargo.

### SUMMARY OF THE INVENTION

The present invention is generally directed to a distributed computing system that supports the rebooking and boarding of passengers at a transportation terminal. The present invention improves upon existing approaches to manage changes in passenger travel plans by using a monitoring software, rebooking systems, and information delivery systems to assist travelers with changing travel plans and to keep travelers informed. Using these various systems, a carrier can anticipate and effectuate rebooking of passengers whose travel plans have changed, thereby reducing bottlenecks and confusion for both the passenger and the carrier. Once passengers have been rebooked, the carrier can use an information display system to provide passengers with their rebooking information immediately upon arrival at the terminal. The information display system presents travel-related information that allows passengers to proceed to the correct departure gate expeditiously and reduces the demands on carrier personnel needed to assist passengers. For those passengers desiring updated documentation reflecting rebooking information, scan-print devices (SPDs) can rapidly provide the user with new documents. Finally, a local computer system at each passenger's departure gate can verify a passenger's identity and rebooking information allowing the passenger to board with minimal inconvenience.

In one aspect, the present invention comprises a method for managing changes in a passenger's travel itinerary. A carrier agent can utilize a flight monitoring software module to identify a passenger requiring rebooking. The rebooking may be necessitated because of changed flight schedules, delays caused by inclement weather or equipment problems, or other reasons. The rebooking may also be initiated by a passenger desiring to change her itinerary. Using the flight monitoring software and the rebooking system, the carrier can rebook the passenger on the next available flight, as well as place the passenger on standby for any earlier flights. When the passenger arrives at the terminal, the information display system can provide the passenger with the new rebooking information, allowing the passenger to proceed either directly to the new gate or to a scan-print device to receive a hard copy of the new itinerary reflecting the rebooking information. The scan-print device can rapidly provide the new itinerary to the user after receiving a single input identifying the passenger. Upon arriving at the departure gate, the passenger can confirm that she is at the correct gate for the rebooked flight by checking the information display system. The local computing system at the departure gate can receive the passenger's rebooking information, typically by scanning the new itinerary or other piece of identification, and confirm that the passenger is permitted to board. While it is not necessary that the passenger receive a hard copy of the rebooked itinerary, passengers often find it desirable to have a tangible copy.

In another aspect, the present invention comprises a method for changing the travel itinerary of a connecting passenger that will be unable to make a connecting flight. A flight monitoring software module can monitor passengers on inbound flights and identify those passengers that will be delayed and unable to make it to connecting flights. Upon identifying such a passenger, the flight monitoring software module can engage the rebooking system to rebook the passenger on the next available flight after her projected arrival. Once the passenger is rebooked, the carrier's systems can deliver the new itinerary information to the passenger via a number of channels. Delivery methods can include displaying the information on an electronic display, transmitting the information to the passenger's personal digital device, and printing a copy of the new itinerary at a scan-print device. The new itinerary information can also be delivered to the local computing system at the passenger's arrival gate and new departure gate. Upon receiving the new itinerary, the passenger can proceed directly to the correct departure gate. When the passenger arrives at the new departure gate and boarding begins, the passenger can present identifying information to the local computing system. The local computing system can verify that the passenger is permitted to board using the new itinerary, an older itinerary, or some other piece of identification.

In another aspect, the present invention comprises a method for providing efficient service to passengers whose travel itineraries have been changed. A rebooking system can receive instructions for rebooking passengers. Once the passenger is rebooked, the rebooking information can be delivered to the passenger when she arrives at the terminal. The rebooking information can be delivered to the passenger through a variety of means including electronic displays and transmission to the passenger's personal communications device. If the passenger would like to receive a printed copy of the rebooking information, she can proceed to a scan-print device. The scan-print device can scan a piece of identification or a document to collect an identifier for the passenger. The carrier's reservation system can use the identifier to retrieve the rebooking information and transmit the information to the scan-print device. With a single input from the passenger comprising identifying data, the scan-print device can rapidly receive and print rebooking information for the passenger. Alternatively, the passenger can use dedicated telephones near the scan-print device to request rebooking information or speak directly to an agent located near the scan-print device and request a copy of the rebooking information. The passenger can then proceed to the correct departure gate with a copy of the rebooking information.

In yet another aspect, the present invention comprises a computer-implemented system for supporting the rebooking and boarding of passengers. The invention comprises a data storage device with the carrier's passenger records and a flight monitoring software module that assists in tracking the passengers. When a passenger requires a change in her travel itinerary, the flight monitoring software can engage the rebooking system to identify the next available flight and initiate the rebooking. The rebooking information is delivered to the passenger using one or more efficient processes. In one example, rebooking information can be delivered using an information display system. In another example, rebooking information can be printed rapidly using a scan-print device that receives an identifying input from the passenger. When the passenger arrives at the airport, she can go directly to the correct departure gate without assistance from a carrier representative. A local computing system at the departure gate also receives the rebooking information and verifies that the passenger is permitted to board.

These and other aspects of the invention will be described below in connection with the drawing set and the appended specification and claim set.

### BRIEF DESCRIPTION OF THE DRAWINGS

FIG. 1 is a functional block diagram illustrating the architecture of a distributed computing network in accordance with an exemplary embodiment of the present invention.

FIG. 2 is a logic flow diagram illustrating a process for rebooking a passenger in accordance with an exemplary embodiment of the present invention.

FIG. 3 is a logic flow diagram illustrating a process for identifying a passenger that will miss a connection in accordance with an exemplary embodiment of the present invention.

FIG. 4 is a logic flow diagram illustrating an exemplary process for rebooking a passenger using one embodiment of the present invention.

FIG. 5 is a logic flow diagram illustrating an exemplary process for delivering rebooking information to a passenger using one embodiment of the present invention.

FIG. 6 is a logic flow diagram illustrating an exemplary process for permitting a rebooked passenger to board using one embodiment of the present invention.

FIG. 7A illustrates an exemplary display screen according to one embodiment of the present invention where several instances of the flight monitoring software are shown.

FIG. 7B illustrates an exemplary display screen according to one embodiment of the present invention where one instance of the flight monitoring software is expanded to show additional passenger and flight information.

FIG. 8A illustrates an exemplary display screen according to one embodiment of the present invention showing a screen for delivering standby passenger information.

FIG. 8B illustrates an exemplary display screen according to one embodiment of the present invention showing a screen for delivering upgrade passenger information.

FIG. 9 illustrates an exemplary display screen according to one embodiment of the present invention showing a screen for delivering cleared standby passenger information.

FIG. 10 illustrates an exemplary display screen according to one embodiment of the present invention showing a screen for delivering rebooking information at a departure gate.

FIG. 11 illustrates an exemplary display screen according to one embodiment of the present invention showing a screen for delivering rebooking information.

FIG. 12 is a functional block diagram illustrating the architecture of a distributed computing network that includes a scan-print device in accordance with an exemplary embodiment of the present invention.

FIG. 13 is a logic flow diagram illustrating a process for rebooking a passenger using a scan-print device in accordance with an exemplary embodiment of the present invention.

FIGS. 14A, 14B, and 14C are logic flow diagrams illustrating a process for providing a passenger with travel documents using a scan-print device in accordance with an exemplary embodiment of the present invention.

FIG. 15 is a logic flow diagram illustrating a process for delivering rebooking information to a passenger at a departure gate in accordance with an exemplary embodiment of the present invention.

FIG. 16 illustrates an isometric view of a scan-print device in accordance with an exemplary embodiment of the present invention.

FIG. 17 illustrates an isometric view of an exemplary scan-print device that is opened to show the interior components of the device.

### DETAILED DESCRIPTION OF THE EXEMPLARY EMBODIMENTS

The present invention provides a method and system that supports the rebooking of passengers. Specifically, one exemplary embodiment anticipates required changes to passenger travel itineraries and efficiently effectuates the rebooking. Another exemplary embodiment supports expedited delivery of the passenger's new itinerary to the passenger. The new itinerary can be delivered to the passenger through the use of electronic displays located in a terminal and at arrival and departure gates. The new itinerary also can be delivered to the passenger's telephone or personal digital device. Delivering rebooking information to the passenger immediately upon arrival at the terminal allows the passenger to proceed directly to the correct departure gate and reduces the amount of customer support that needs to be provided by carrier agents. If the passenger desires an updated copy of her itinerary reflecting the rebooking information, she can proceed to a scan-print device. The scan-print device receives an identifier from the passenger and rapidly retrieves and prints new documents for the passenger. A further exemplary embodiment supports the delivery of the passenger's new booking information to a local computer system at the departure gate. Supplying the local computer system with the passenger's updated travel information allows the passenger to board with the new documents, previously issued documents, or other identification.

A representative embodiment of the present invention is described herein in the context of a commercial air carrier. It should be understood that air transportation is only one exemplary embodiment of the inventive concept and that additional embodiments of the invention can be used to support other modes of transportation, such as by train, bus, or ship. The invention also has applications beyond the transportation industry where tracking of large volumes of people is performed. For example, the invention could be implemented to manage the passage of people through a common area to multiple destinations, including in an amusement park and a multiplex theater. Additionally, the invention could be applied to the shipping and rerouting of cargo and packages.

Although the exemplary embodiments will be generally described in the context of software modules running in a distributed computing environment, those skilled in the art will recognize that the present invention also can be implemented in conjunction with other program modules for other types of computers. In a distributed computing environment, program modules may be physically located in different local and remote memory storage devices. Execution of the program modules may occur locally in a stand-alone manner or remotely in a client/server manner. Examples of such distributed computing environments include local area networks of an office, enterprise-wide computer networks, and the global Internet.

The detailed description which follows is represented largely in terms of processes and symbolic representations of operations in a distributed computing environment by conventional computer components, including remote file servers, remote computer servers, processing units, local computer systems, local or remote memory storage devices, display devices and input devices. Each of these conventional distributed computing components is accessible by the processing unit via a communications network.

The processes and operations performed by the distributed computing environment include the manipulation of signals by a processing unit or remote server and the maintenance of these signals within data structures resident in one or more of the local or remote memory storage devices. Such data structures impose a physical organization upon the collection of data stored within a memory storage device and represent specific electrical or magnetic elements. These symbolic representations are the means used by those skilled in the art of computer programming and computer construction to most effectively convey teachings and discoveries to others skilled in the art.

The present invention also includes computer programs that embody the functions described herein and illustrated in the appended flow charts. However, it should be apparent that there could be many different ways of implementing the invention in computer programming, and the invention should not be construed as limited to any one set of computer program instructions. Further, a skilled programmer would be able to write such a computer program to implement the disclosed invention without difficulty based on the flow charts and associated description in the application text, for example. Therefore, disclosure of a particular set of program code instructions is not considered necessary for an adequate understanding of how to make and use the invention. The inventive functionality of the claimed computer program will be explained in more detail in the following description in conjunction with the remaining figures illustrating the program flow.

Referring now to the drawings, in which like numerals represent like elements throughout the several figures, aspects of the present invention and an exemplary operating environment will be described.

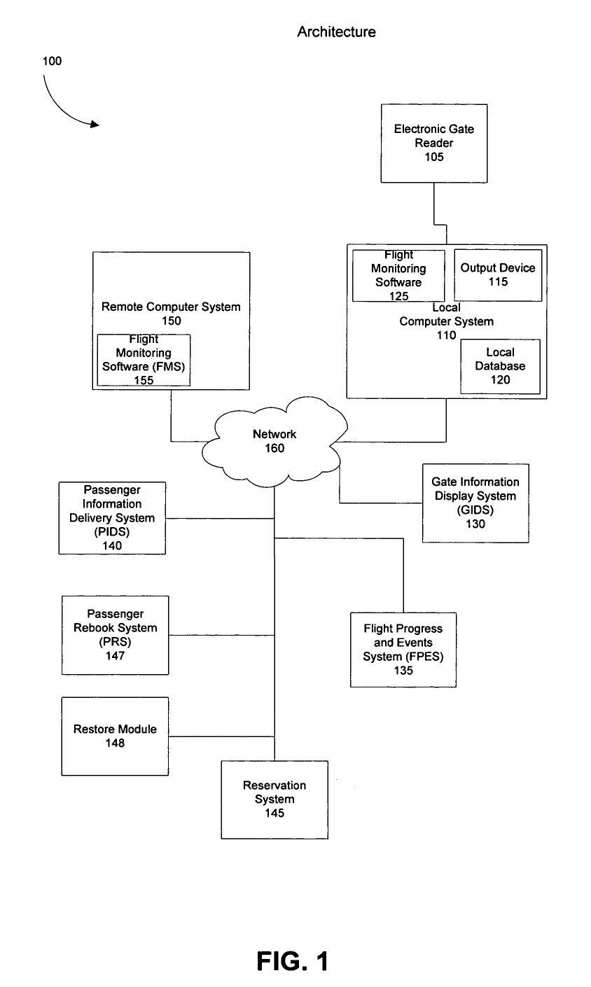

FIG. 1 illustrates various aspects of an exemplary computing environment in which the present invention is designed to operate. Those skilled in the art will appreciate that FIG. 1 and the associated discussion are intended to provide a brief, general description of the preferred computer hardware and program modules, and that additional information is readily available in the appropriate programming manuals, user's guides, and similar publications.

FIG. 1 illustrates the architecture 100 for supporting the operation of an exemplary embodiment of the present invention for performing a rebooking process. As shown in FIG. 1, a flight monitoring software module 155 (sometimes referred to as “FMS”) operates on a remote computer system 150. The remote computer system 150 is typically located in the carrier's back office and is remote from the activities of the terminal. A carrier agent using the flight monitoring software 155 operating on the remote computer system 150 can monitor a passenger on a particular flight to determine whether the passenger will arrive at the airport with adequate time to make a connecting flight. If it does not appear that the passenger will be able to make the connecting flight, the carrier's agent can revise the passenger's itinerary so that the passenger will have a reservation on the next available flight that accommodates the passenger's arrival time. It should be obvious to one skilled in the art that the process of identifying a passenger unable to make a connection and rescheduling the passenger on a later flight can also be automated so that it can be performed without the assistance of an agent.

Although the exemplary embodiment described in the drawings appended hereto addresses the situation of a passenger on an inbound flight that has a connecting flight, the teachings described herein can also be applied to solve other problems with rebooking of passengers. For example, the carrier's agent can also monitor and revise passenger itineraries that are affected by weather delays, equipment problems, or other changes in flight schedules. In another embodiment, the carrier's agent can be equipped to receive a request from a passenger for revising an itinerary and change the itinerary accordingly.

The remote computer system 150 is coupled to one or more dynamic databases. In the exemplary representation in FIG. 1, the remote computer system 150 is coupled to a passenger information delivery system (PIDS) 140 and a flight progress and events system (FPES) 135. The PIDS 140 contains the carrier's passenger records. The FPES 135 contains the carrier's flight data and can provide connecting flight information to the local computer system 110. The flight monitoring software module 155 is designed such that several separate instances of the software can be operating simultaneously, each instance corresponding to a particular flight. When an instance of the flight monitoring software 155 is opened for a particular flight, the flight monitoring software 155 subscribes to PIDS 140 and FPES 135 and obtains the data related to that flight. As passenger and flight information changes, the dynamic databases 135 and 140 are updated and current data is provided to the flight monitoring software 155.

The local computer system 110 comprises a local database 120 for storing passenger and flight information. The local computer system 110 can also comprise flight monitoring software module 125 and an output device 115 for displaying passenger and flight information to a gate agent. When preparing to board a flight through a particular gate, the local computer system located at that gate can subscribe to the FPES 135 and the PIDS 140 to obtain current information for the departing flight. If a passenger's itinerary has changed and she is now on the departing flight, the current data concerning that passenger is transmitted to the local computer system 110. In receiving the most current passenger data, the local computer system 110 can expediently identify those passengers scheduled to depart on the outbound flight and allow them to board.

An electronic gate reader 105, operable for reading passenger data from a boarding card, is coupled to the local computer system 110. Alternatively, the electronic gate reader 105 can also read other media comprising passenger and flight information. Examples of ways in which the electronic gate reader 105 operates include scanning a bar code or reading a magnetic strip on a passenger's boarding card. Passenger information is transmitted by the electronic gate reader to the local computer system where it is determined whether a passenger is authorized to board an aircraft.

The gate information display system (GIDS) 130 coupled to the network 160 allows the carrier to provide current, passenger-specific itinerary updates to passengers as they arrive at the airport. The GIDS 130 comprises electronic display screens that can display passenger and flight information. The electronic display screens of the GIDS 130 are typically located proximate to boarding and arrival gates. Its name notwithstanding, the GIDS can also be located in places other than the terminal gates. For example, the electronic display screens can be located onboard aircraft, at hotels, and at designated waiting areas. In alternative embodiments of the invention, transmitters can be used in conjunction with or in place of the GIDS system. The transmitters can send itinerary updates to passenger telephones, PDAs, or other types of communication or computing devices upon their arrival at the airport. The prompt delivery of updated itineraries allows passengers to proceed immediately to the correct gate upon arriving at the terminal without needing the assistance of carrier personnel. Further details of an exemplary embodiment of a GIDS system are described in U.S. patent application Ser. No. 09/708,890 entitled “Method and System for Providing Dynamic and Real-Time Air Travel Information” and incorporated herein by reference.

In the exemplary architecture 100, the carrier also employs a reservation system 145 coupled to the network 160. The reservation system 145 manages and stores data related to passenger reservations. In an embodiment where the rebooking process is automated, the reservation system 145 can instruct the passenger rebook system 147 to rebook a passenger that has been identified as requiring a new travel reservation. Once the booking is revised, the passenger rebook system 147 notifies the restore module 148 of the revised booking. The restore module 148 can check the passenger in, assign a seat for the passenger, copy meal and assistance information from the original booking, and reroute the passenger's luggage, among other processes.

Although FIG. 1 shows only one remote computer system 150 and one local computer system 110 coupled to the network 160, it should be understood that the preferred embodiment of the invention operates with multiple local computer systems and remote computer systems. The local computer system 110 is typically proximate to a boarding gate, however, a single local computer system 110 can support multiple boarding gates. Furthermore, a carrier agent can manage the boarding process through one or more gates from a “back office” location using the local computer system.

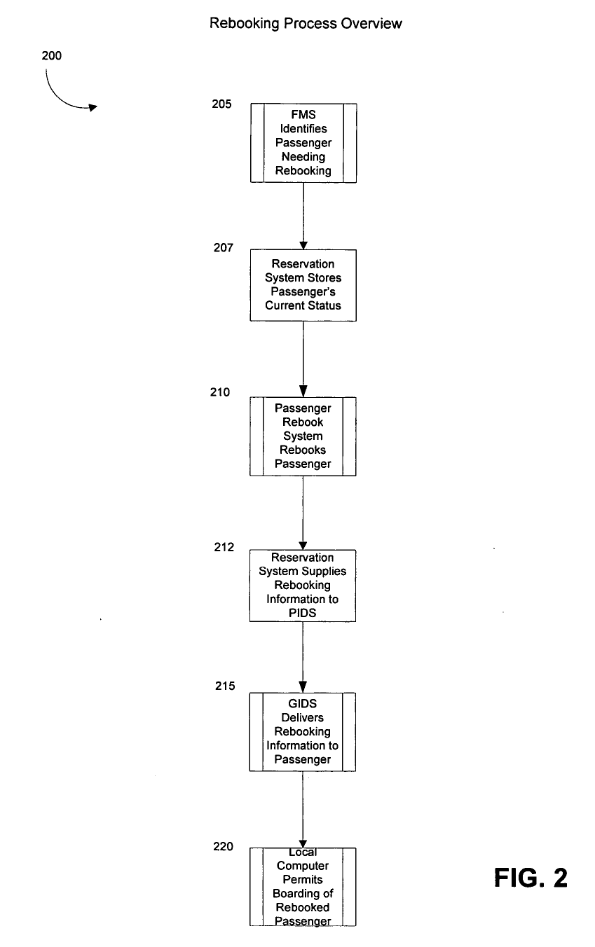

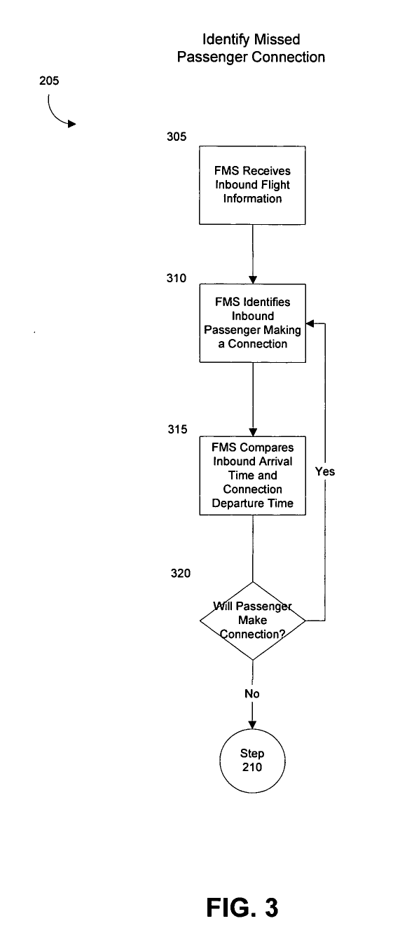

FIG. 2 illustrates an exemplary process 200 for performing a rebooking process in accordance with the present invention. FIG. 2 is a high-level illustration of the process and the subsequent figures will describe the steps of the process 200 in greater detail. Beginning with step 205, a passenger requiring a rebooking is identified. The identification step can be performed by a carrier agent using a flight monitoring software module 155. Alternatively, the flight monitoring software module 155 can automatically identify a passenger requiring a rebooking. For example, the flight monitoring software module 155 can monitor passengers on inbound flights that are scheduled for a connecting flight as further described in FIG. 3. Alternatively, the reservation system 145 can identify passenger reservations requiring a rebooking because of a canceled flight or changed flight schedule.

Once the passenger requiring a change in her itinerary is identified, the reservation system 145 stores the passenger's current status, including the information associated with the existing reservation, in step 207. In step 210, the passenger rebook system 147 receives a trigger from the reservation system 145 and rebooks the passenger's itinerary. As with the identification step, the rebooking process also can be performed manually by a carrier agent. The identification and rebooking steps 205 and 210 can be utilized when there has been a change in the carrier's flight schedule or unanticipated delays due to weather or equipment problems. In alternate embodiments, the passenger can initiate the rebooking by contacting the carrier and requesting a change to a travel itinerary. When the rebooking is completed, the reservation system 145 supplies the rebooking information to PIDS 140 in step 212.

In step 215, the GIDS 130 will receive the passenger's rebooking information from the carrier's computer system and convey that information to the passenger. The gate information display system 130 can receive the rebooking information from the reservation system 145 or from a specific source of passenger information such as the PIDS 140. The gate information display system 130 provides the new rebooking information to the passenger via a system of electronic display screens. The electronic display screens can be located at departure gates and other convenient locations throughout the terminal. The electronic screens on which a particular passenger's rebooking information is displayed can be strategically selected so that the passenger is more likely to receive the information. For example, if the passenger is arriving on a flight that has been delayed, the updated rebooking information can be displayed on GIDS displays proximate to the passenger's arrival gate. Alternatively, in the case of a canceled flight, the rebooking can be displayed at the gate for the canceled flight and the gate for the rebooked flight. If the passenger is a member of a frequent flyer program, the rebooking information also can be shown on GIDS displays that are proximate to specific frequent flyer waiting areas.

Lastly, in step 220, the local computer system 110 can permit the rebooked passenger to board through the departure point. The local computer system 110 also receives the passenger's rebooking information from the carrier's reservation system 145 or the passenger information delivery system 140. The local computer system 110 is typically located proximate to the departure point. The electronic gate reader device 105 coupled to the local computer system 110 can receive identifying information from the passenger before boarding in order to verify her identity. Once the local computer system 110 verifies the rebooked passenger's identity, she is free to board. The processes illustrated in FIGS. 3, 4, 5 and 6 will describe the steps of process 200 in greater detail.

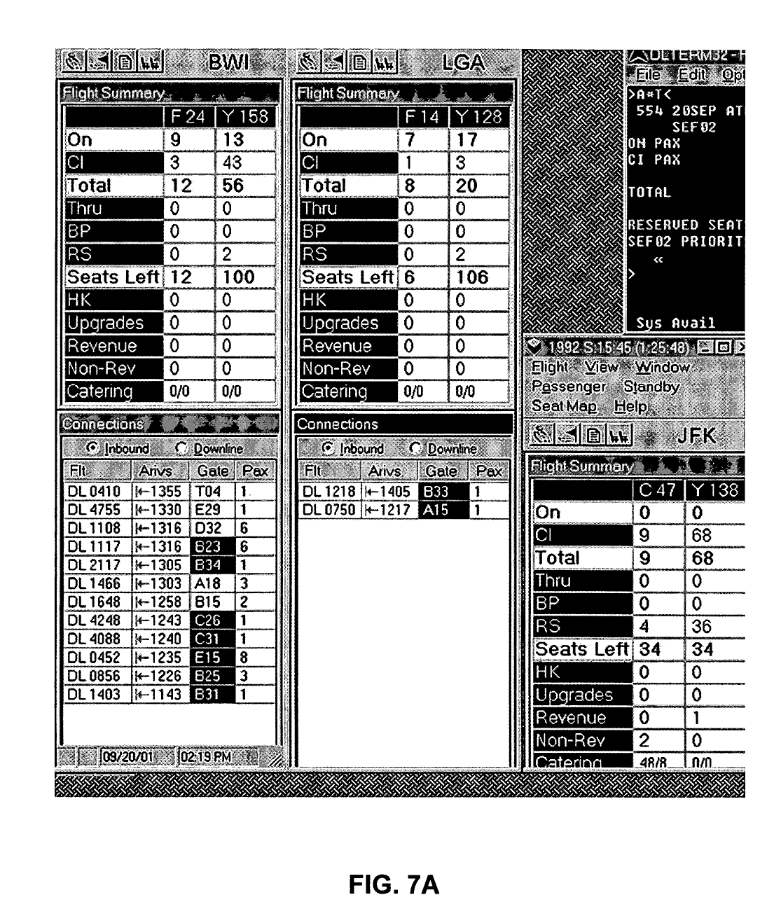

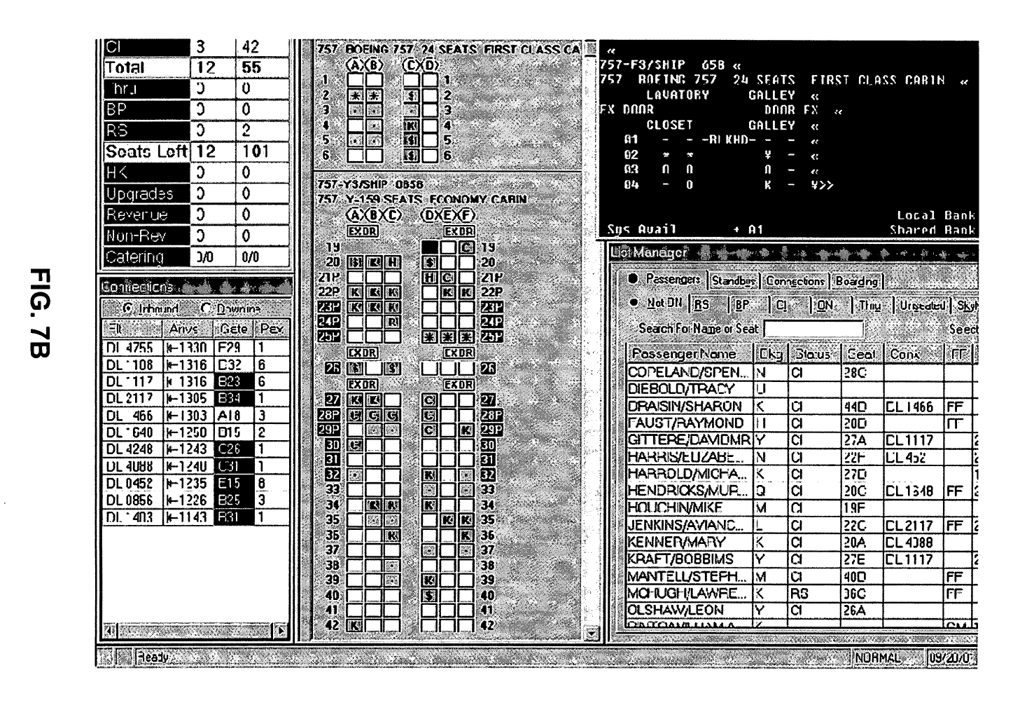

Process 205, illustrated in FIG. 3, shows an exemplary process for identifying a passenger requiring a rebooking. Specifically, process 205 concerns a passenger on an inbound flight that is scheduled to board a connecting flight. Alternative embodiments of the present invention can identify passengers other than those on an inbound flight with connections. In step 305, the flight monitoring software module 155 receives flight information for an inbound flight. The information displayed by the flight monitoring software module can include the passenger's name, the passenger's seat, whether the passenger has baggage, and whether the passenger has a connecting flight. Exemplary display screens illustrating the information displayed by the flight monitoring software module are shown in FIGS. 7A and 7B. In step 310, those passengers on the inbound flight that have a connection are identified by the flight monitoring software module 155. In step 315, the estimated arrival time of the inbound flight can be compared to the estimated departure time of the connecting flight to see whether or not the passenger will be able to make their connecting flight.

Steps 310 and 315 of process 205 can be performed either automatically by the flight monitoring software module 155 or, alternatively, by a carrier agent operating the flight monitoring software module 155. In step 320, if it is determined that the passenger will make her connection, the passenger's booking information will remain the same and another passenger will be examined. Alternatively, if the passenger will not make her connecting flight or is unlikely to make her connecting flight, the rebooking process described in step 210 is performed. The identification process 205 anticipates when a passenger will not be able to make their flight and will require a modification in their travel itinerary. By anticipating the need for a rebooking, the entire rebooking process can be expedited and the carrier can better serve its customers. Alternatively, instead of anticipating needed rebookings, the carrier can also respond more efficiently to unexpected changes in flight schedules or requested changes in itineraries from passengers.

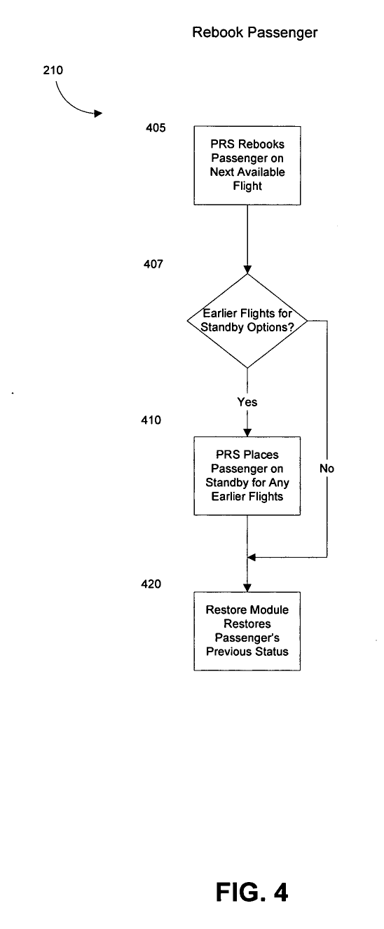

The carrier is able to make the rebooking process 210 more efficient by identifying in advance those passengers that will need a rebooking. In step 405 of FIG. 4, the passenger rebook system 147 can rebook the passenger on the next available flight. Alternatively, an agent can access the reservation system 145 and manually rebook the passenger on the next available flight after they are estimated to arrive.

In step 407, the passenger rebook system 147 can check for flights earlier than the one rebooked in step 405. If there are earlier flights that the passenger may be able to board the passenger rebook system 147 can also place a passenger on standby in step 410. After the passenger is rebooked or placed on standby, the restore module 148 restores the passenger's previous status using the information from the original booking that the reservation system 145 stored in step 207. The new rebooking information can comprise the reservation on a later flight as well as any standby reservations. Once the passenger's rebooking information is restored in step 420, the rebooking is stored in the reservation system 145 so that it can be accessed by the carrier's other systems to effectuate boarding.

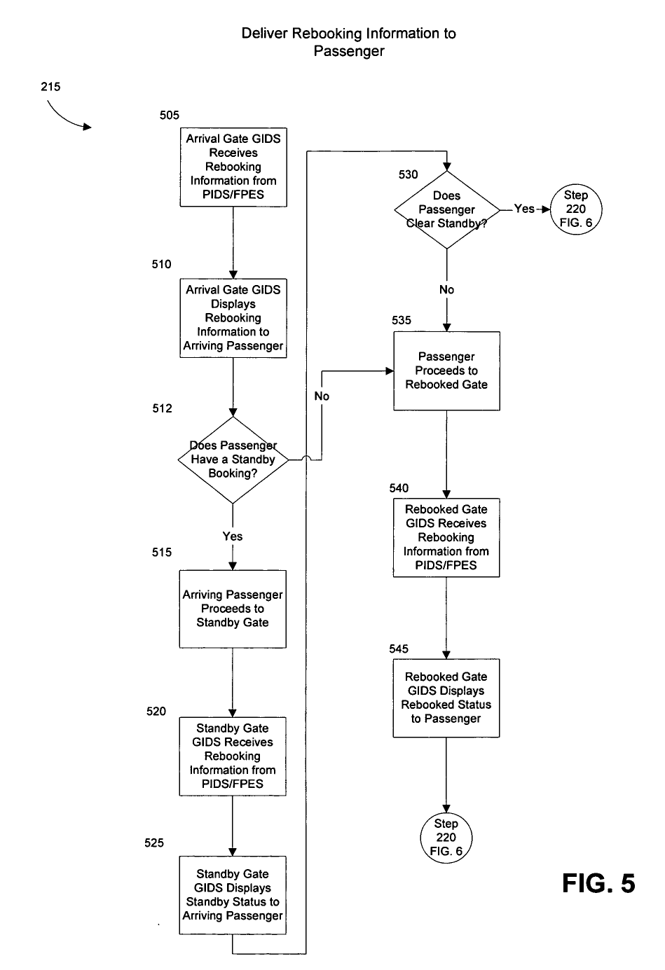

FIG. 5 illustrates an exemplary process 215 for delivering the passenger's new travel information to the passenger upon their arrival at the terminal. Rapidly providing the new rebooking information to the passenger will streamline the rebooking and boarding process and eliminate many of the passenger's questions. The exemplary process 215 illustrated in FIG. 5 addresses the delivery of information to a passenger on an inbound flight with a connection. Alternative embodiments of the invention can address the delivery of information to passengers arriving at the terminal in other ways or to passengers waiting to depart from a gate. In step 505, the GIDS screen 130 at the arrival gate receives the rebooking information from the passenger information delivery system 140. Exemplary rebooking information displayed on the GIDs screen can include the passenger's reservation on a later flight, the gate for the flight, and any possible standby information. The rebooking information can also be delivered to other GIDS screens proximate to the passenger's arrival gate. The GIDS 130 located at an arrival gate typically has several different screens of information that can be displayed to passengers. One of these screens can address information directed to passengers deplaning from a flight that has just arrived.

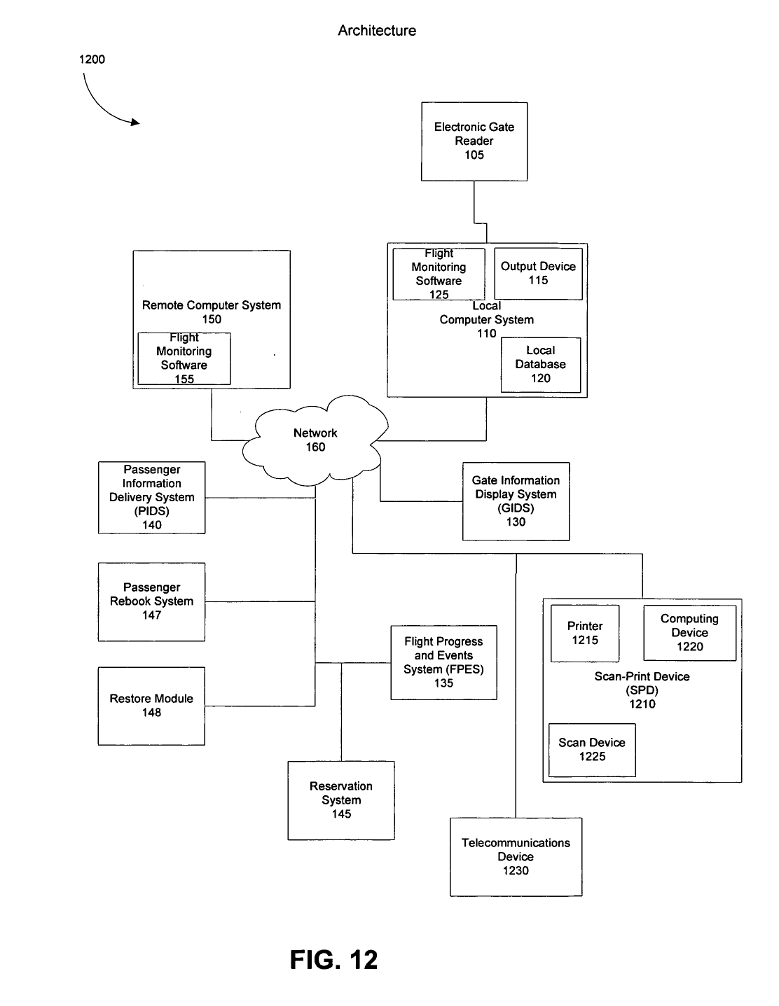

In step 510, the GIDS 130 at the arrival gate, and possibly other nearby GIDS screens, display the rebooking information to the arriving passenger as she deplanes and passes through the arrival gate. A representative GIDS screen displaying rebooking information to passengers is illustrated in FIG. 11. If the passenger does not have a standby reservation in step 512, she can proceed directly to the rebooked gate in step 535. Alternatively, if there is a standby reservation, the arriving passenger that has been delayed and missed her connection will read the rebooking information from the GIDS display screen and can then proceed to the correct standby gate in step 515. Alternatively, if the passenger was not placed on a flight on standby status, she can proceed directly to the flight for which she has been rebooked.

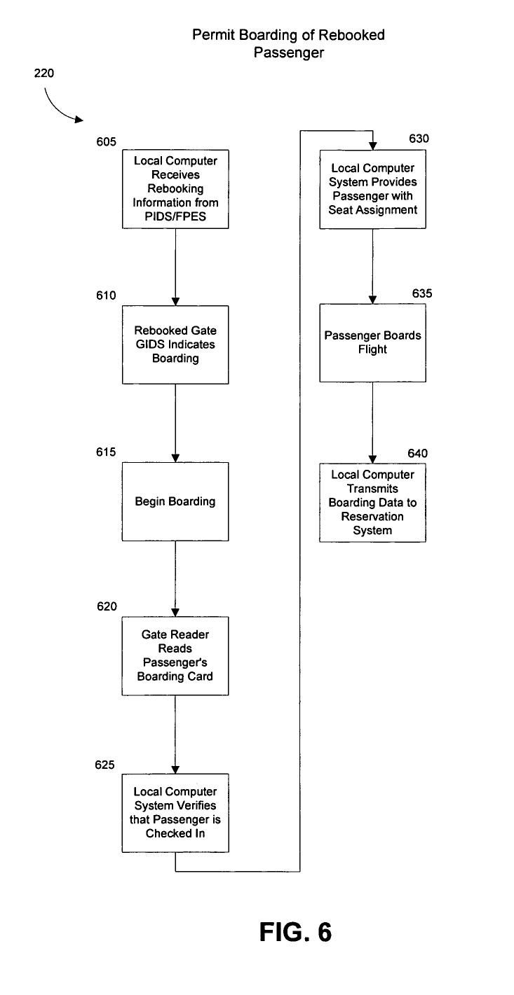

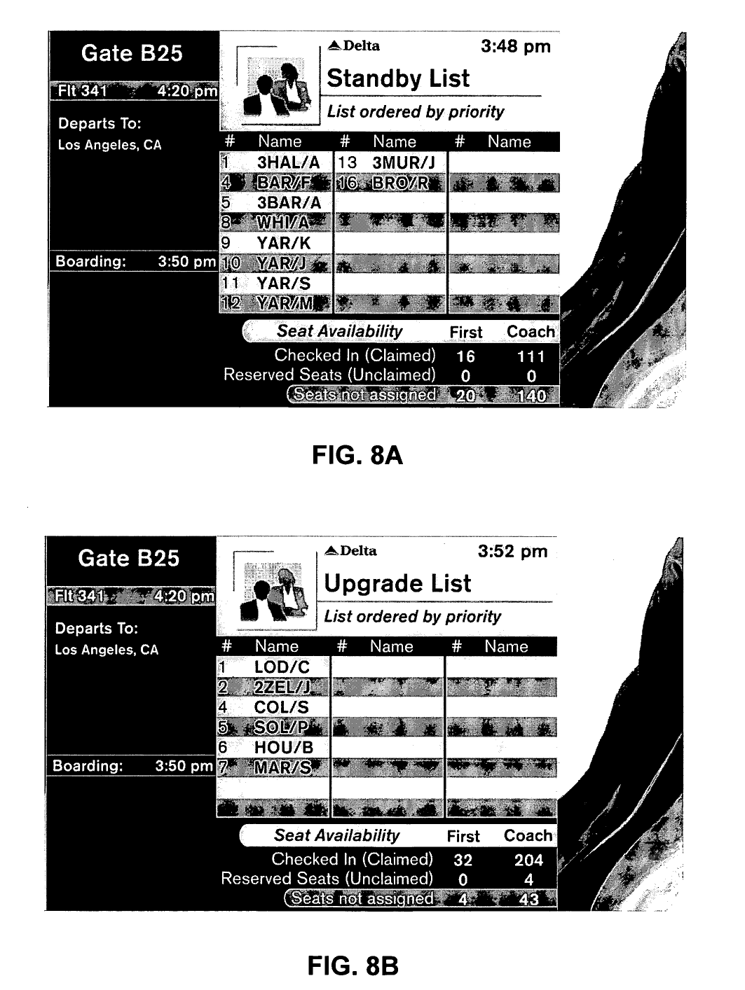

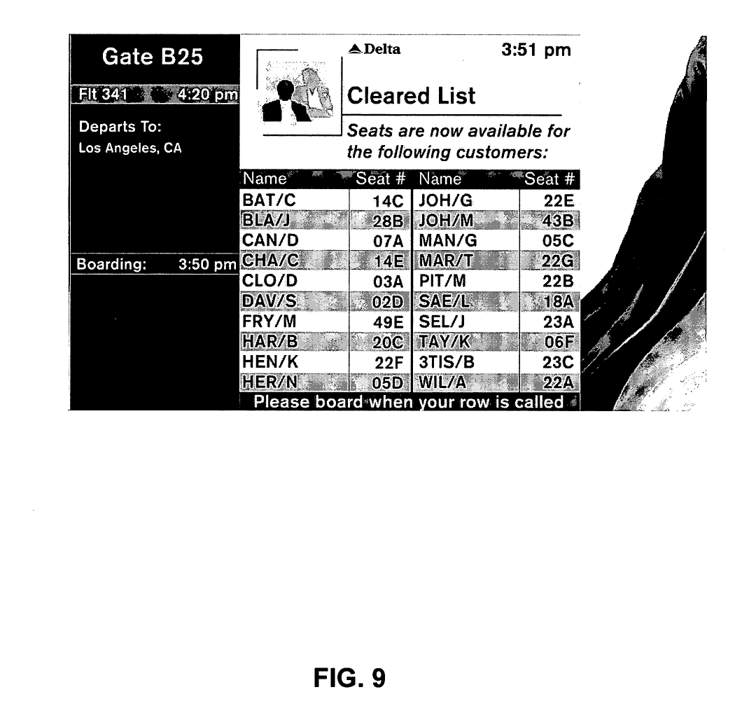

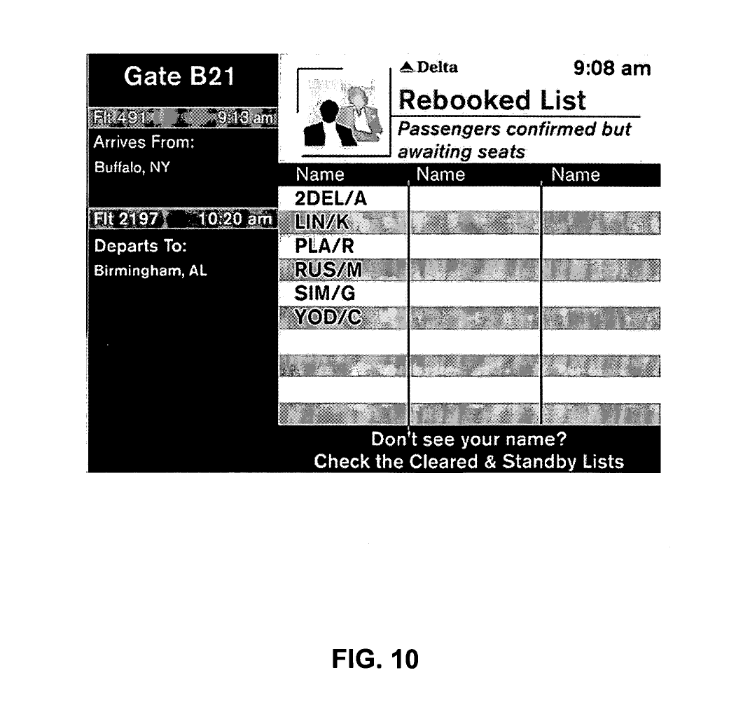

In step 520, the GIDS 130 located at the standby gate will also receive the rebooking information from the PIDS 140. By displaying this information, in step 525, at the departure gate for the flight for which the passenger is on standby status, this will reconfirm for the passenger their status and let them know that they have proceeded to the correct gate. An exemplary screen display showing standby information is illustrated in FIG. 8A. FIG. 8A shows that the information on the standby screen comprises the flight, the departure gate, seat availability, the passenger's name (using the first three letters of the last name and the first initial), and the passenger's priority rank. Similarly, the passenger may be waiting for a seat upgrade. The GIDS 130 can display an upgrade list such as the exemplary list illustrated in FIG. 8B. If the passenger clears standby status in step 530, she will be permitted to board and can proceed to the boarding process illustrated in FIG. 6. An exemplary screen display showing passengers that have cleared standby status is illustrated in FIG. 9.

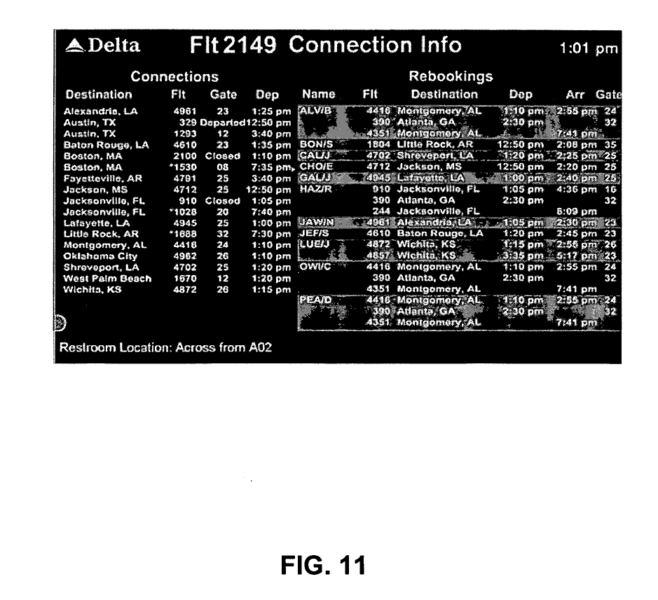

Alternatively, if the passenger is unable to clear standby status, they can proceed to the gate for which they are rebooked on a flight in step 535. The GIDS 130 located at the rebooked gate will receive the rebooking information from PIDs 140 as well. The GIDS system located at the rebooked gate will display this information to the passenger so that she knows it is the correct gate for the new flight. A representative screen display located at the rebooked gate showing rebooking information is illustrated in FIG. 10.

The final step of the rebooking concerns boarding, as illustrated in exemplary process 220 for boarding a passenger that has been rebooked. In contrast to conventional rebooking systems where passengers are required to speak with a carrier agent and receive new documentation reflecting the change in their itinerary, the present invention supports boarding of the passenger without the creation of new documents. In step 605 of FIG. 6, the local computer system 110 at the passenger's departure gate also receives the passenger's new rebooking information from the passenger information delivery system 140. The GIDS 130 located at the departure gate will have already received and displayed the passenger's rebooking information to assist the passenger in identifying the correct departure gate. When boarding begins, the GIDS 130 displays the passenger's name as one of those scheduled to board on the departing flight.

In step 615, upon being prompted by the GIDS 130 in step 610, the passengers will begin to board the flight through the departure gate. When the rebooked passenger reaches the departure gate, she can present her identifying information to the local computer system 110. The rebooked passenger's identity can be ascertained from a variety of different pieces of information. The passenger may be able to use her original boarding card, a permanent identity card issued by the carrier, a driver's license, or a passport. Alternatively, the local computer system 110 may use other biometric methods of ascertaining the passenger's identity.

Upon receiving the passenger's identifying information, in step 625, the local computer system will verify that the passenger is checked in for the flight that is scheduled to depart. The local computer system 110 will check the rebooked passenger's identity against the rebooking information it previously received from the PIDs 140. In step 630, after the local computer system has verified that the passenger may board, the passenger seat assignment can be displayed. Alternatively, the local computer system 110 may print out a hard copy of the passenger's seat or, may simply direct the passenger to board without a particular seat assignment. In step 635, the passenger then proceeds through the boarding gate and boards the flight. The local computer system 110 will then transmit the fact that the passenger has boarded to the reservation system 145. The fact that the passenger has boarded will be used to update the carrier's records.

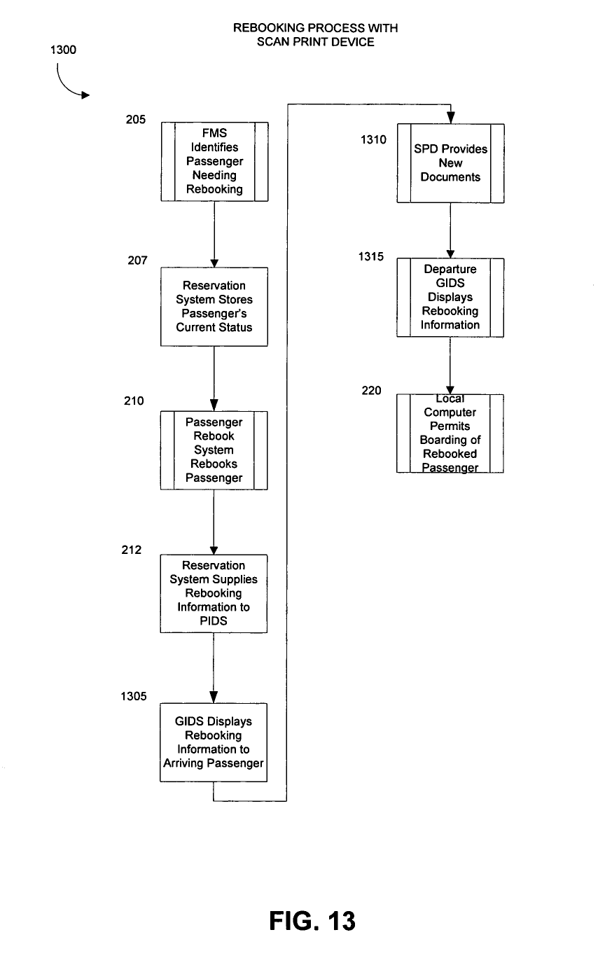

FIG. 12 illustrates architecture 1200 for operating another exemplary embodiment of the present invention. In addition to the components illustrated in exemplary architecture 100 shown in FIG. 1, architecture 1200 includes additional components for providing passengers with documents reflecting changes to travel itineraries. In particular, FIG. 12 illustrates a representative scan-print device 1210 coupled to network 160. The scan-print device 1210 comprises a scan device 1225 for receiving an identifying input from the passenger. The scan device 1225 is typically implemented as a bar code scanner or magnetic strip reader. However, alternate embodiments of the present invention can employ other types of input devices, such as a biometric scanner for reading a fingerprint or retina. In another embodiment, the scan-print device 1210 can comprise an RF scanner that interrogates an RF-enabled chip located in a tag or identification card. Use of the word “scan” should not be interpreted as limiting the ways in which the scan-print device 1210 can receive an input identifying the passenger.

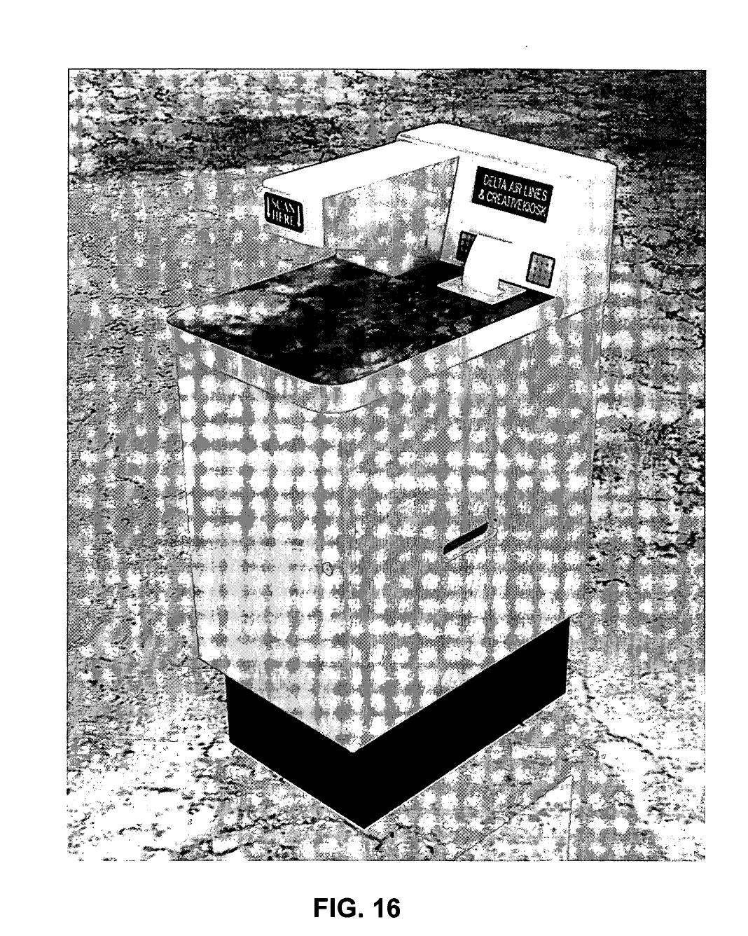

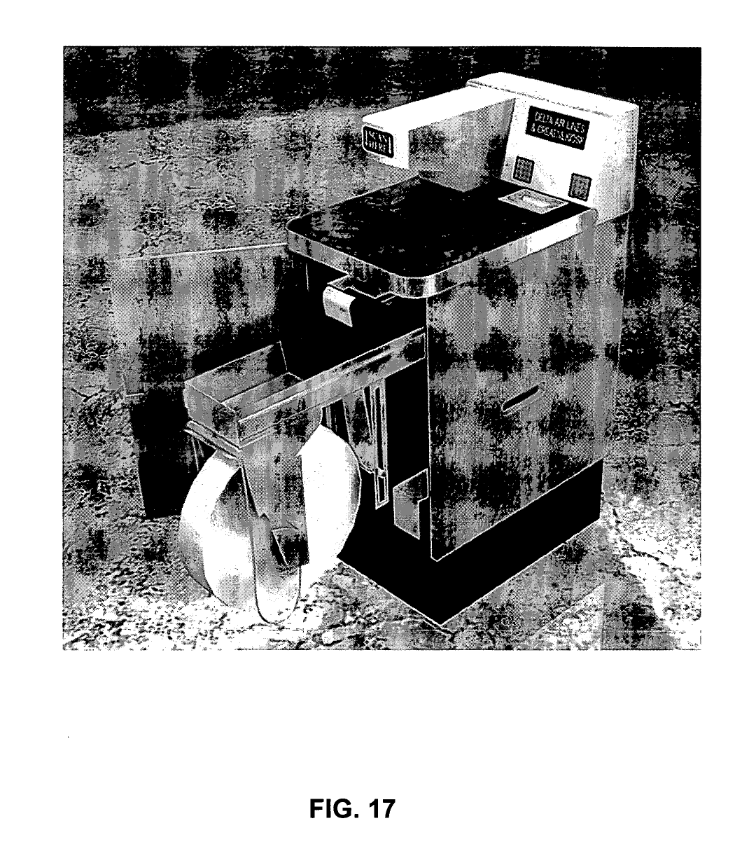

The scan-print device 1210 further comprises a computing device 1220 that receives the passenger identifier from the scan device 1225. The computing device 1220 uses the passenger identifier to communicate with the other systems illustrated in FIG. 12 and retrieves the passenger's updated itinerary comprising the rebooking information. Once the computing device 1220 receives the rebooking information, the printer 1215 can print a hard copy of the new information for the passenger. The scan-print device 1210 can also receive amenity information associated with the passenger's rebooking or itinerary. For example, if the passenger received food or hotel vouchers in connection with the rebooking, this information can also be printed for the passenger. Because the scan-print device 1210 generally only requires a single identifying input from the passenger, it is well-adapted to manage transactions for a large volume of passengers in a short period of time. FIGS. 16 and 17 provide additional illustrations of an exemplary scan-print device 1210.

Exemplary architecture 1200 also illustrates telecommunication device 1230 coupled to network 160. Telecommunications device 1230 is typically implemented in the exemplary embodiment as one or more dedicated telephones located proximate to a scan-print device 1210. If a passenger is unfamiliar with the scan-print device or prefers to speak with a carrier agent, she can use the telephone to ask questions about the rebooking or ask for a new rebooking. Alternatively, a carrier agent can be located near the scan-print device 1210. The carrier agent can speak directly with passengers that have questions and provide passengers with rebookings.

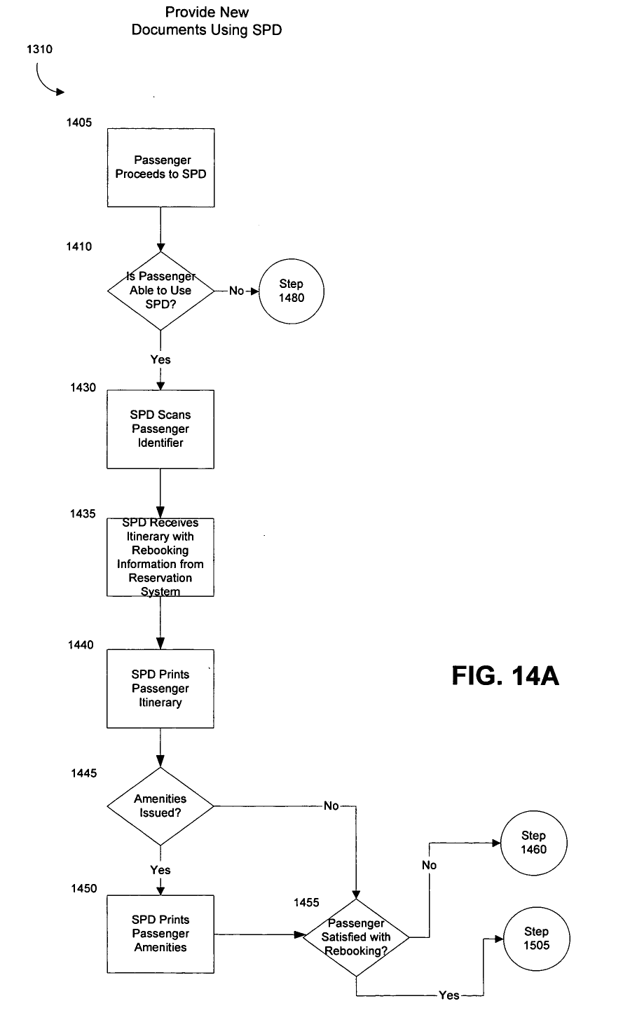

FIG. 13 illustrates an exemplary process 1300 for rebooking a passenger using the scan-print device 1210. Exemplary process 1300 begins with steps 205, 207, 210, and 212 for identifying and rebooking passengers. These steps are described in greater detail in connection with FIGS. 2, 3, and 4. Once the rebooking is complete and the passenger arrives at the terminal, the GIDS 130 can display the rebooking information to the passenger in step 1305. As an alternative to or in conjunction with GIDS 130, the rebooking information can be transmitted to the passenger's personal digital device or telephone. Furthermore, in other embodiments of the present invention, passengers may learn about their rebooking through other means, such as from speaking with an agent or receiving information on an inbound flight. The carrier can also make audible announcements of general information about flight changes and prompts to remind passengers to check for rebooking information.

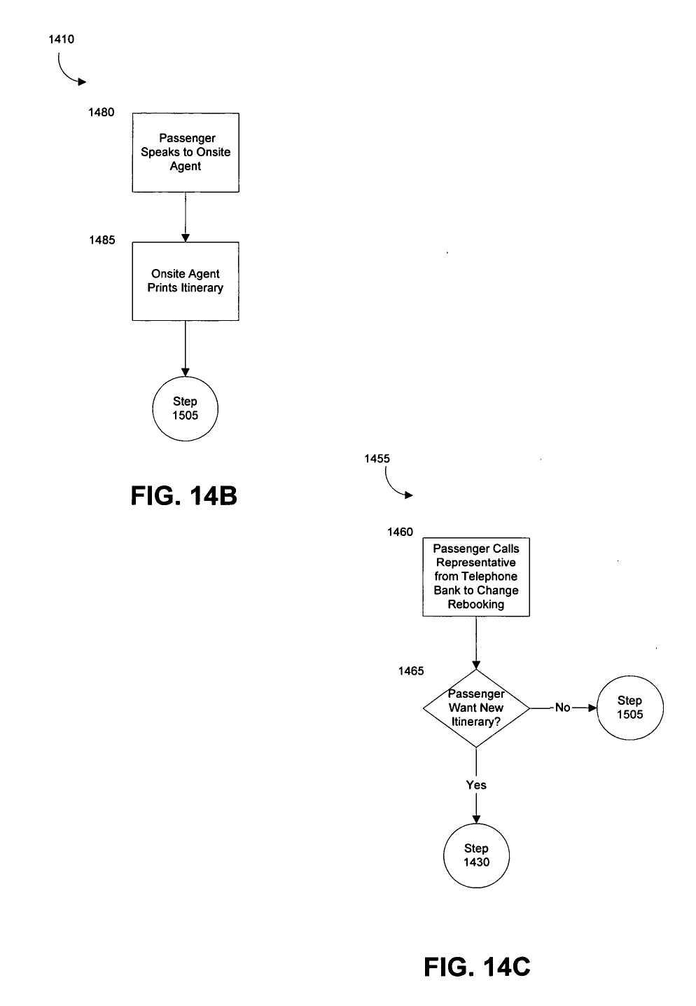

A passenger that would like a hard copy of their itinerary or rebooking information can proceed to a scan-print device 1210 in step 1310. Scan-print devices 1210 can be positioned at convenient locations throughout travel terminals and concourses. The scan-print device 1210 provides the passenger with a rapid and efficient method for receiving a paper confirmation of the change in her travel plans. The process for providing the new documents is described in greater detail in connection with FIG. 14A.

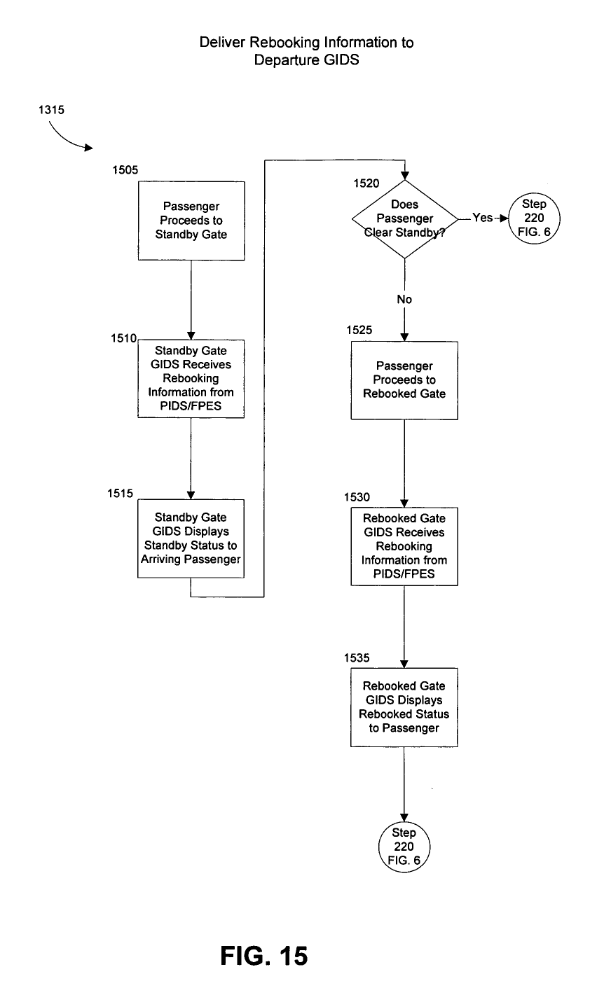

Once the passenger receives her new documents from the scan-print device 1210, she can proceed to the correct departure gate. In step 1315, a GIDS 130 can also be implemented at the departure gate to display the rebooking information as well as other information associated with the departing flight. The process for displaying the rebooking information at the departure gate is described in greater detail in connection with FIG. 15. Lastly, in step 220, the local computer system at the departure gate receives the rebooking information so that the rebooked passenger can be permitted to board. The processes performed in step 220 are described in greater detail in connection with FIGS. 2 and 6.

Those skilled in the art will understand that exemplary process 1300 is merely one method for implementing a rebooking process with the scan-print device 1210. Certain steps recited in process 1300 could be performed in a different order or omitted entirely. For example, step 1305 could be removed from exemplary process 1300 and an arriving passenger could proceed directly to a scan-print device 1210 to learn the status of her rebooking.

Referring to FIG. 14A, exemplary process 1310 is illustrated in greater detail. Exemplary process 1310 begins with the passenger proceeding to a scan-print device 1210. If the passenger has a boarding document or other identification that the scan-print device 1210 can scan, she can simply proceed with scanning the document or identification in step 1430. However, at step 1410, if the passenger does not have a document or piece of identification that the scan-print device 1210 can scan or if the passenger prefers to speak to a carrier agent, the passenger can speak directly to an on-site agent in step 1480 of FIG. 14B. The on-site agent can provide the passenger with the rebooking in step 1485 and the passenger can proceed to the appropriate gate in step 1505.

Referring again to step 1430, assuming the passenger does have a document or piece of identification that the scan device 1225 can read, the computing device 1220 can use the identifier to communicate with the PIDS 140. Once the PIDS 140 locates the passenger's itinerary using the identifier that was provided, the computing device 1220 at the scan-print device 1210 receives the passenger's itinerary in step 1435. In step 1440, the printer 1215 can print a copy of the rebooking for the passenger. In some instances, there may be other documents that the carrier can provide to the passenger. For example, in step 1445, if the carrier issued amenities such as food or hotel vouchers in connection with the rebooking, the scan-print device 1210 can print the amenity vouchers in step 1450.

Once the passenger receives the rebooking, she may decide that she wants to change the rebooking in step 1455. In that case, the passenger can call a carrier agent using telecommunications device 1230 in step 1460 of FIG. 14C. After receiving the second rebooking from the representative, the passenger can proceed to step 1505 in FIG. 15. Alternatively, the passenger can obtain a copy of the second rebooking by returning to step 1430.

Those skilled in the art will appreciate that process 1310 is only one example of an implementation of the invention. In alternative embodiments of the invention, steps illustrated in process 1310 can be performed in a different order or omitted entirely. For example, a passenger may know how to use the scan-print device 1210 in step 1410, but may nonetheless choose to call a representative in step 1460 to discuss her situation. After the itinerary is received in step 1440, the passenger may elect to speak directly to the onsite agent in step 1480.

The scan-print device's ability to rapidly retrieve a passenger's rebooking information using a single input is a significant improvement over conventional electronic kiosks. Conventional electronic kiosks typically require several interactions with a passenger in order to complete a transaction. In contrast, a passenger can simply scan a piece of identification using the scan-print device 1210 and the rebooking information can be retrieved and printed. The efficiency of the scan-print device 1210 allows for processing of a large volume of passengers in a short period of time, such as when inclement weather alters the travel plans of many passengers.

Once the passenger receives a copy of the rebooking information, she can proceed to the appropriate departure gate. FIG. 15 illustrates an exemplary process 1315 for delivering rebooking information to the passenger using the GIDS 130. Although the passenger typically has a copy of the rebooking information printed at the scan-print device 1210, the GIDS 130 can be used to confirm that the passenger is at the correct departure gate and to notify the passenger of any subsequent changes in her itinerary. In step 1505, the passenger proceeds to the standby gate where the next available flight is departing. In the example illustrated in FIG. 15, the passenger rebook system 147 placed the passenger on a standby list for the next available flight. The local computer system 110 at the standby gate receives the rebooking information from FPES 135 and PIDS 140 in step 1510. The GIDS 130 located at the standby gate displays the rebooking information so that the passenger can confirm that she is at the correct gate in step 1515. In alternative embodiments, the passenger may forgo the standby opportunity, skipping steps 1505-1515, and proceed directly to the rebooked departure gate.

If the passenger clears standby in step 1520, she can proceed with boarding as described in step 220. If the passenger does not clear standby, she proceeds to the rebooked gate in step 1525. The GIDS 130 at the rebooked gate can also display the passenger's rebooking information so that the passenger can confirm that she is at the correct departure gate. In step 1530, the GIDS 130 at the rebooked gate receives the rebooking information for the passenger. As the flight is preparing for boarding, the GIDS 130 displays the rebooking information for the passenger along with the other pre-boarding information that is typically displayed. Once boarding commences, the rebooked passenger can board as described in step 220.

In conclusion, the present invention, as represented in the foregoing exemplary embodiments, enables a carrier to simplify and expedite the rebooking of passengers. This process is particularly useful for rebooking connecting passengers on later flights so that they can proceed directly to the correct gate upon arriving at the airport. This process is also helpful for a carrier that has to make numerous rebookings in a short period of time such as when flight schedules are changed because of weather or equipment problems. Quickly identifying and rebooking those passengers that require a change in their itinerary allows the carrier to make efficient use of available seating on all flights. Delivering the rebooking information to the passengers immediately upon arrival also reduces the amount of carrier personnel needed at the terminal and gates to assist passengers, as well as the stress and uncertainty faced by passengers as their itineraries are changed. If a rebooked passenger prefers, she can quickly receive a hard copy of the rebooking information by presenting a piece of identification at a scan-print device. Finally, delivering the rebooking information to the passenger's new departure gate streamlines the boarding process.

It will be appreciated that the present invention fulfills the needs of the prior art described herein and meets the above-stated objects. While there has been shown and described the preferred embodiment of the invention, it will be evident to those skilled in the art that various modifications and changes may be made thereto without departing from the spirit and the scope of the invention as set forth in the appended claims and equivalents thereof. For instance, the present invention could be used by other commercial carriers for rail and boat transportation and to support connections among different modes of air, ground, and water transportation. The invention can also be used in other environments where patrons pass through a single departure point, such as in an amusement park or multiplex theater. Although the present invention has been described as operating in a distributed computing environment, it should be understood that the invention can be applied to other types of computing systems.

What is claimed is:

1. A computer-implemented method for providing a passenger with rebooking information comprising the steps of:
creating a new itinerary for the passenger, the new itinerary comprising rebooking information;
delivering the rebooking information to the passenger upon arrival at a travel terminal;
forwarding the rebooking information to a scan-print device in response to receiving an input from the passenger; and
printing the rebooking information with the scan-print device.

2. The method of claim 1, further comprising the step of receiving an instruction to create the new itinerary.

3. The method of claim 1, further comprising the step of forwarding the rebooking information to a computer proximate to a departure gate at the travel terminal that permits the passenger to board.

4. The method of claim 1, wherein the step of delivering the rebooking information comprises displaying the rebooking information proximate to a departure gate.

5. The method of claim 1, wherein the step of receiving an input comprises receiving only a single input from the passenger.

6. The method of claim 1, wherein the step of receiving an input from the passenger comprises reading a passenger identifier from a card or document.

7. The method of claim 1, wherein the step of receiving an input from the passenger comprises reading a biometric passenger identifier.

8. The method of claim 1, wherein the step of delivering the rebooking information to the passenger comprises delivering the rebooking information to the passenger's personal digital device.

9. The method of claim 1, wherein the step of delivering the rebooking information to the passenger is associated with an audio announcement.

10. The method of claim 1, wherein the step of creating the new itinerary is performed in response to identifying that the passenger will not arrive in time to board a scheduled departure.

11. A computer-readable medium comprising computer-executable instructions for performing the steps recited in claim 1.

12. A computer-implemented method for changing the booking of a passenger on an inbound flight from a first connecting flight to a second connecting flight comprising the steps of:
identifying that the passenger on the inbound flight will not arrive in time to board the first connecting flight;
generating rebooking information by rebooking the passenger on the second connecting flight in recognition that the passenger on the inbound flight will not arrive in time to board the first connecting flight;
receiving an identifier for the passenger from a single input received at a scan-print device; and
transmitting the rebooking information corresponding to the identifier to the scan-print device for printing a copy of the rebooking information for the passenger.

13. The computer-implemented method of claim 12, further comprising the step of printing amenity documents associated with the rebooking information.

14. The computer-implemented method of claim 12, further comprising the step of forwarding the rebooking information to a computing device proximate to the departure gate that controls boarding.

15. The computer-implemented method of claim 12, further comprising the step of displaying the rebooking information proximate to an arrival gate associated with the inbound flight.

16. The computer-implemented method of claim 12, further comprising the step of making an announcement at an arrival gate associated with the inbound flight, the announcement associated with the rebooking information.

17. The computer-implemented method of claim 12, further comprising the step of displaying the rebooking information proximate to a departure gate associated with the second connecting flight.

18. The computer-implemented method of claim 12, further comprising the step of making an announcement at a departure gate associated with the second connecting flight, the announcement associated with the rebooking information.

19. A computer-readable medium comprising computer-executable instructions for performing the steps recited in claim 12.

20. A method for assisting a passenger with a rebooking comprising:
receiving a single input comprising a passenger identifier;
requesting rebooking information associated with the passenger identifier from a reservation system, the rebooking information created in response to a monitoring software module that identified the passenger as unable to board a scheduled departure;
receiving the rebooking information from the reservation system; and
printing a copy of the rebooking information for the passenger.

21. The method of claim 20, further comprising the steps of:
receiving amenity information associated with the rebooking information; and
printing a copy of the amenity information for the passenger.

22. The method of claim 20, wherein the passenger identifier is received from scanning a card or document belonging to the passenger.

23. The method of claim 20, wherein the passenger identifier is received from a telecommunications device.

24. A computer-readable medium comprising computer-executable instructions for performing the steps recited in claim 20.

25. A method for assisting a passenger with an itinerary comprising:
receiving an instruction to change the passenger's itinerary from a first departure to a second departure;
rebooking the passenger on the second departure and storing the rebooking as rebooking information;
delivering the rebooking information to the passenger upon arrival at a travel terminal;
receiving a request for a copy of the itinerary comprising the rebooking information; and
transmitting the travel itinerary comprising the rebooking information to a scan-print device for printing a copy of the rebooking information.

26. The method of claim 25, wherein the request for a copy of the itinerary comprises a passenger identifier.

27. The method of claim 25, further comprising the step of transmitting amenity information associated with the rebooking information to the scan-print device for printing a copy of the amenity information.

28. The method of claim 25, wherein the rebooking information is delivered to the passenger with an electronic display.

29. The method of claim 25, wherein the rebooking information is delivered to the passenger on the passenger's personal digital device.

30. A computer-readable medium comprising computer-executable instructions for performing the steps recited in claim 25.

31. A system for providing a passenger with a new itinerary comprising:
a scan device operable for receiving a passenger identifier;
a computing device coupled to the scan device and a reservation system, the computing device operable for retrieving the new itinerary corresponding to the passenger identifier, the new itinerary comprising rebooking information created in response to identifying that the passenger would miss a scheduled departure; and
a printer coupled to the computing device and operable for printing a copy of the new travel itinerary.

32. The system of claim 31, wherein the computing device is further operable for retrieving amenity information associated with the new itinerary.

33. The system of claim 31, wherein the scan device requires only a single interaction with the passenger.

34. The system of claim 31, further comprising a gate information display system coupled to the reservation system and operable for displaying the rebooking information.

35. The system of claim 31, further comprising a local computing system located proximate to a boarding gate and operable for receiving the rebooking information and comparing the rebooking information to the passenger identifier.
